(19) United States
(12) Patent Application Publication
(10) Pub. No.: US 2007/0133596 A1
(43) Pub. Date: Jun. 14, 2007

(54) EPON system and method for traffic scheduling in EPON system

(76) Inventor: Jun-Seog Kim, Seoul (KR)

Correspondence Address: Robert E. Bushnell, Suite 300, 1522 K Street, N.W., Washington, DC, 20005, US

(21) Appl. No.: 11/633,003

(22) Filed: Dec. 4, 2006

(30) Foreign Application Priority Data
Dec. 12, 2005 (KR) 10-2005-0122160

(51) Int. Cl. H04J 3/22; H04J 3/00

(52) U.S. Cl. 370/465; 370/498

(57) ABSTRACT

In an Ethernet passive optical network (EPON) system and a method for traffic scheduling in the EPON system, the method comprises: dividing a periodic transmission cycle between an optical line termination (OLT) and an optical network unit (ONU) for upstream traffic time band assignment into an Expedited Forwarding (EF) sub-cycle preset for EF traffic and an Assured Forwarding (AF) sub-cycle dynamically set for AF and BE traffic; dynamically assigning, by means of the OLT receiving ONU queue length information from the ONU, a first AF sub-cycle band using the queue length information and the preset EF sub-cycle band; and granting to the ONU, by means of the OLT, a first preset EF sub-cycle band, the dynamically assigned first AF sub-cycle band, and a second preset EF sub-cycle band. Thus, EF traffic band assignment for the next cycle is performed one cycle in advance, thereby reducing idle time and significantly enhancing overall bandwidth efficiency.

### CLAIM OF PRIORITY

This application makes reference to, incorporates the same herein, and claims all benefits accruing under 35 U.S.C.§119 from an application earlier for EPON SYSTEM AND METHOD OF TRAFFIC SCHEDULING THEREOF, filed in the Korean Intellectual Property Office on the 12^{th} of Dec. 2005 and there duly assigned Serial No. 10-2005-0122160.

### BACKGROUND OF THE INVENTION

1. Technical Field

The present invention relates to an Ethernet passive optical network (EPON) system and a method for traffic scheduling in the EPON system.

2. Related Art

A passive optical network (PON) has a subscriber network structure in which several optical network units (ONUs) are connected to one optical line termination (OLT) using a passive splitter in order to build a distributed topology having a tree structure. The PON can build a highly reliable, inexpensive access network by reducing the total length of an optical line and using only passive optical devices, and can deliver signals from several subscribers to a high-speed infrastructure network by combining and multiplexing the signals. Thus, the PON has been suggested as a suitable system for implementing Fiber To The Home (FTTH) and Fiber To The Curb (FTTC).

The PON includes four elements such as an OLT, an optical distribution network (ODN), an ONU, and an element management system (EMS).

The OLT serves as an interface between a PON and a backbone network, like an edge switch. The EMS operates, manages and maintains the entire PON system, and monitors the performance of the PON system. However, the OLT may generally include an EMS function. This is because the OLT is intended to have all of the functions of the PON, which reduces the functional and economical burden on the ONU, and thus the PON system maintenance and installation costs. The ODN is composed of only passive optical devices such as optical fiber, a splitter and a connector, and has a bus or tree structure. The ONU is a section which is directly connected to a subscriber network, and the position of which varies with its application, such as Fiber To The Building (FTTB), FTTC, Fiber To The Office (FTTO), and FTTH.

Examples of PONs include an ATM PON (APON), a Gigabit-capable PON (GPON), an Ethernet PON (EPON), and a Wavelength Division Multiplexing PON (WDMPON), which have been developed or are currently being developed. Among these examples, the EPON is increasingly attracting attention as an attractive solution in a broad-band, high-speed subscriber network because it employs a popular Ethernet technique and realizes low Ethernet equipment cost and optics-based cost. In the EPON, it is highly important to control upstream traffic because different ONUs should share an upstream channel to send data. Furthermore, as the EPON is continuously studied, bandwidth use efficiency and quality of service (QoS) have been of much concern.

Idle time is problematic in upstream transmission control using a cyclic polling system. Accordingly, there is need for a solution which is capable of reducing idle time while allowing the use of the cyclic polling system.

### SUMMARY OF THE INVENTION

Accordingly, it is an object of the present invention to provide an Ethernet passive optical network (EPON) system and a method for traffic scheduling in the EPON system, capable of reducing an idle time by modifying an optical line termination (OLT) granting method in a cyclic polling system.

According to an aspect of the present invention, a method for traffic scheduling in an Ethernet passive optical network (EPON) system comprises the steps of: dividing a periodic transmission cycle between an optical line termination (OLT) and an optical network unit (ONU) for upstream traffic time band assignment into an expedited forwarding (EF) sub-cycle preset for EF traffic and an assured forwarding (AF) sub-cycle dynamically set for AF and best effort (BE) traffic; dynamically assigning, by means of the OLT receiving ONU queue length information from the ONU, a first AF sub-cycle band using the queue length information and the preset EF sub-cycle band; and granting, by the OLT, a first preset EF sub-cycle, the first dynamically assigned AF sub-cycle, and a second preset EF sub-cycle band to the ONU.

The method comprises the steps of: transmitting, by means of the ONU, DATA including the AF and BE traffic and REPORT, including the queue length information for each traffic, to the OLT using the first AF sub-cycle bandwidth granted by the OLT; and transmitting, by means of the ONU, the EF traffic to the OLT using the second EF sub-cycle bandwidth granted by the OLT.

The method further comprises the steps of: receiving, by means of the OLT, the EF traffic from the ONU, dynamically assigning a second AF sub-cycle band using the ONU queue length information and a third preset EF sub-cycle; and granting, by means of the OLT, the second assigned AF sub-cycle and a third EF sub-cycle band to the ONU.

The band assigned to the EF sub-cycle may be the same every cycle for the same ONU.

According to another aspect of the present invention, a method for traffic scheduling in an Ethernet passive optical network (EPON) system comprises: dividing a periodic transmission cycle between an optical line termination (OLT) and an optical network unit (ONU) for upstream traffic time band assignment into an EF sub-cycle preset for EF traffic and an AF sub-cycle dynamically set for AF and BE traffic; performing a first cycle step at the OLT of dynamically assigning, by means of the OLT receiving ONU queue length information from the ONU, a first AF sub-cycle band using the queue length information and the preset EF sub-cycle band, and granting a first preset EF sub-cycle, the first dynamically assigned AF sub-cycle, and a second preset EF sub-cycle band to the ONU; and performing a first cycle step at the ONU of transmitting, by means of the ONU, DATA including the AF and BE traffic and REPORT, including the queue length information for each traffic, to the OLT using the first AF sub-cycle bandwidth granted by the OLT, and transmitting the EF traffic to the OLT using the second EF sub-cycle bandwidth granted by the OLT.

According to still another aspect of the present invention, there is provided an optical line termination (OLT), wherein the OLT receives ONU queue length information from an ONU, dynamically assigns a first AF sub-cycle band using the queue length information and a preset EF sub-cycle, and grants the first preset EF sub-cycle, the first dynamically assigned AF sub-cycle, and a second preset EF sub-cycle band to the ONU.

According to yet another aspect of the present invention, there is provided an EPON system comprising at least one ONU for transmitting DATA including the AF and BE traffic and REPORT, including queue length information for each traffic, to an OLT using the first AF sub-cycle bandwidth granted by the OLT, and for transmitting the EF traffic to the OLT using the second EF sub-cycle bandwidth granted by the OLT.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 illustrates downstream data flow in an Ethernet passive optical network (EPON) system;

FIG. 2 is a diagram illustrating upstream data flow in the EPON system;

FIG. 3 is a diagram illustrating a bandwidth assignment process using an interleaved polling system;

FIG. 4 is a diagram illustrating a bandwidth assignment process using a cyclic polling system;

FIG. 5 is a diagram illustrating a method for traffic scheduling using a Hybrid Granting (HG) algorithm according to an exemplary embodiment of the present invention;

FIG. 6 is a diagram illustrating another HG algorithm according to an exemplary embodiment of the present invention;

FIG. 7 is a diagram illustrating the configuration of an EPON system according to an exemplary embodiment of the present invention;

FIG. 8 is a diagram illustrating a method for traffic scheduling in the EPON system according to an exemplary embodiment of the present invention;

FIG. 9 is a diagram of an operational procedure between an optical line termination (OLT) and an optical network unit (ONU) according to traffic scheduling of the present invention;

FIG. 10 is a graph illustrating an expected theoretical value of the maximum use efficiency when traffic scheduling is performed according to an exemplary embodiment of the present invention, as compared to that of another existing method; and

FIG. 11 is a graph illustrating an experimental value of use efficiency with respect to a traffic load when traffic scheduling is performed according to an exemplary embodiment of the present invention, as compared to that of another existing method.

### DETAILED DESCRIPTION OF THE INVENTION

Hereinafter, exemplary embodiments of the present invention will be described in detail with reference to the accompanying drawings. In the following description, a detailed description of known functions and configurations incorporated herein has been omitted for conciseness.

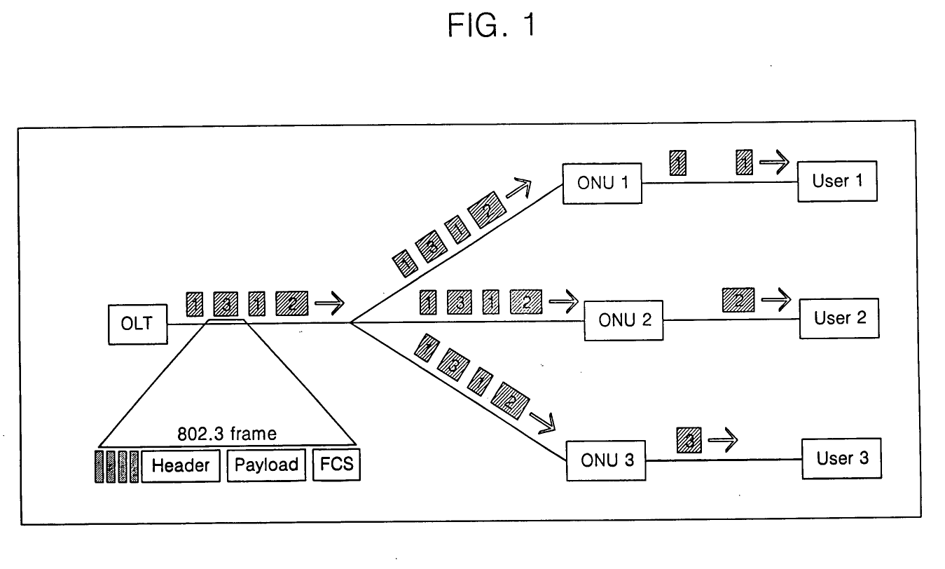

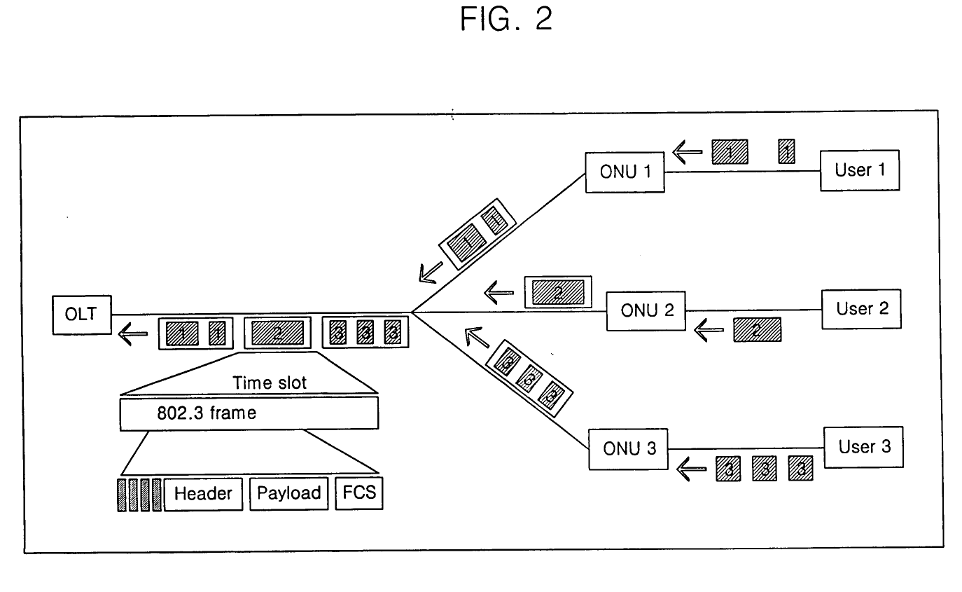

FIG. 1 is a diagram illustrating downstream data flow in an Ethernet passive optical network (EPON) system, and FIG. 2 is a diagram illustrating upstream data flow in EPON system.

As shown in FIG. 1, in the EPON system, downstream transmission flow from an external network to subscribers is from optical line termination (OLT) to all optical network units (ONUs) in a point to multi-point manner due to a physical tree connection characteristic. On the other hand, since an upstream flow from the subscribers to the external network is based on a point to point concept between ONU and OLT, as shown in FIG. 2, each distributed ONU should deliver data without conflicting with one OLT. EPON uses a TDMA system as a band assignment system for upstream band access from a number of ONUs to one OLT.

In the EPON system, static bandwidth allocation (SBA), in which a fixed time slot is assigned to each ONU, may be used for the TDMA system. SBA is easily implemented but uses bandwidth inefficiently. Accordingly, a Multi Point Control Protocol (MPCP) is defined by IEEE 802.3ah EFM Ethernet in First Mile Task to obtain efficient statistical multiplexing in the EPON structure. Using such an MPCP, OLT performs dynamic bandwidth assignment (DBA) to schedule an upstream between ONUs. Messages used upon dynamic band assignment in the MPCP control message are GATE and REPORT. Upstream data transmission control between ONUs is performed by means of an ONU which transmits transmission standby queue length information to the OLT through the REPORT message, and by means of the OLT activating a MAC layer during the granted transmission time when receiving the GATE message indicating transmission granted by a dynamic bandwidth assignment algorithm.

To perform the dynamic bandwidth assignment, the OLT should know a current queue state of the ONU. A method for collecting a queue state of the ONU at the OLT uses an interleaved polling system and a cyclic polling system.

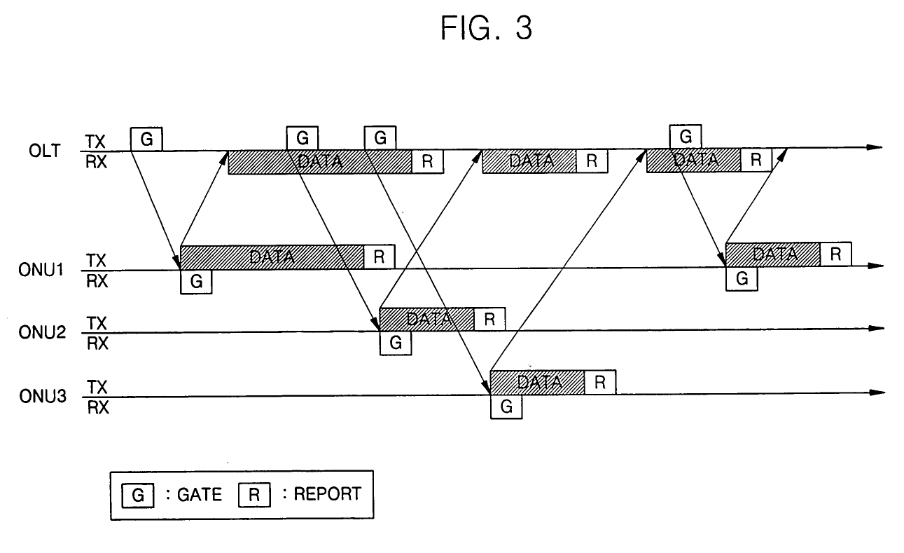

FIG. 3 is a diagram illustrating a bandwidth assignment process using an interleaved polling system.

In FIG. 3, the interleaved polling system performs a dynamic assignment process in which, when the OLT sends a GATE message to the next ONU using downstream transmission before an ONU having a current transmission right completes transmission, the ONU having the transmission right transmits a REPORT message, including its queue state information together with data information, to the OLT. In the interleaved polling system, the duration of one period varies with the assigned bandwidth. Thus, the duration of one period increases when the input load is great. This limits the maximum transmissible band, which is called a maximum transmission window (MTW).

The interleaved polling system can provide high bandwidth use efficiency. However, because the duration of one period varies with the assigned bandwidth, the interleaved polling system is not suitable for real-time services which are sensitive to delay. Furthermore, when there is less upstream traffic, the number of GATE and REPORT messages increases. Thus, overhead of both the upstream bandwidth and the downstream bandwidth increases.

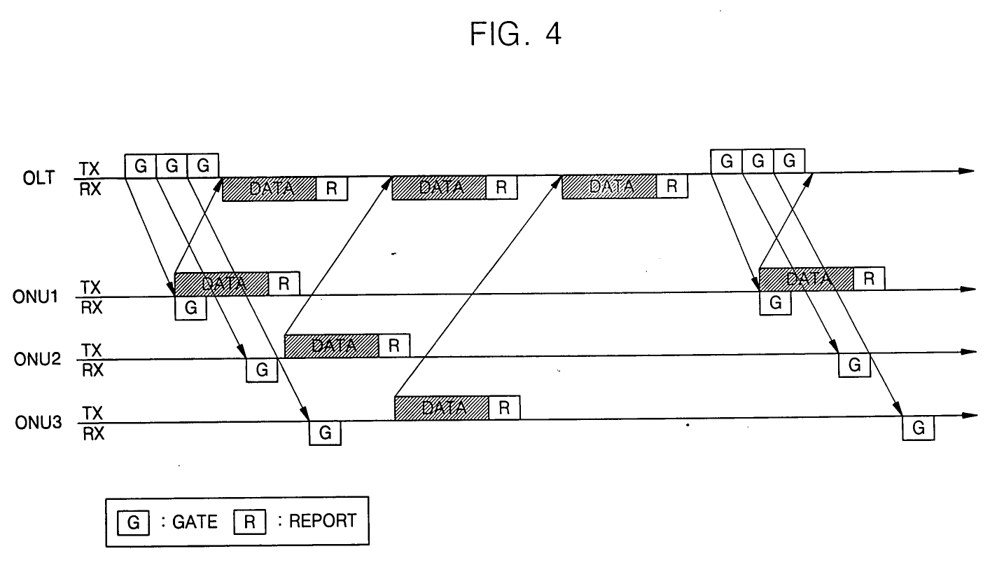

FIG. 4 is a diagram illustrating a bandwidth assignment process using a cyclic polling system.

In the cyclic polling system shown in FIG. 4, polling is performed on all ONUs in a predetermined polling period. A variety of band assignment algorithms, and a minimum and maximum band assignment policy for each ONU, can be easily applied to cyclic polling. Accordingly, the number of DBA algorithms supporting quality of service (QoS) employ the cyclic polling method. However, the use of the cyclic polling method causes an idle time when there is no data transmission flow so that upstream bandwidth use efficiency (throughput) is degraded in comparison to that of the interleaved polling system.

In this regard, the idle time can be represented by the sum of round trip time (RTT) and DBA computation time. The DBA computation time is the time taken to process the dynamic band assignment algorithm at the OLT, and has a value which varies with CPU speed. The use of a high-speed CPU significantly reduces the DBA computation time. Thus, the DBA computation time can be ignored.

However, the case is different with RTT. For example, the maximum RTT value becomes 200 μs since the maximum distance between the OLT and the ONU in the EPON is 20 km. When the period is 2 ms, 200 μs corresponds to 10% of the period. That is, a great deal of weight may be placed on the idle time to degrade the bandwidth use efficiency.

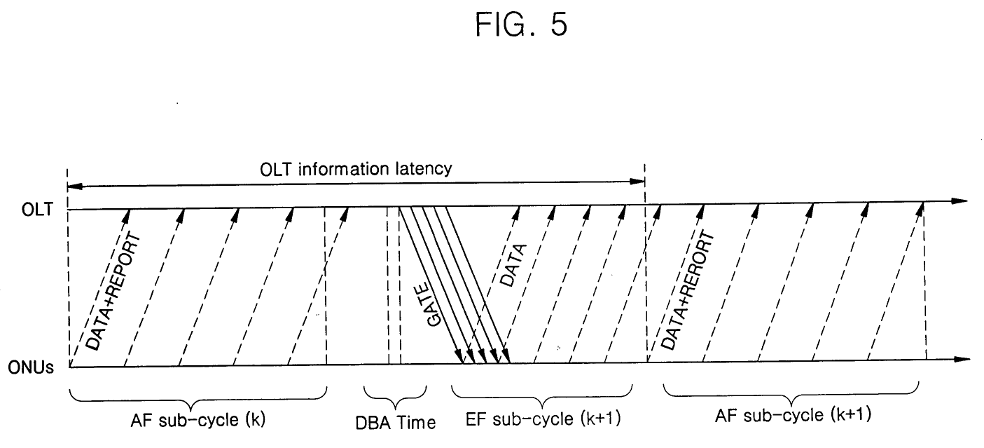

FIG. 5 is a diagram illustrating a method for dynamically assigning a band using a Hybrid Granting (HG) algorithm according to an exemplary embodiment of the present invention.

The HG algorithm is based on the cyclic polling method. Upstream traffic is classified according to Expedited Forwarding (EF), Assured Forwarding (AF), and Best Effort (BE) classes. Bandwidth assignment is performed in divided EF and AF sub-cycles. The EF class is the highest priority class for a service that is sensitive to delay, such as constant bit rate (CBR) voice traffic. The AF class is a middle priority class which is not sensitive to delay, such as Variable Bit Rate (VBR). The BE class is the lowest priority class for services such as FTP, WEB browsing, and E-mail application programs.

In the HG algorithm, a bandwidth assignment cycle is divided into two sub-cycles in order to reduce EF class delay and delay variation.

Referring to FIG. 5, a fixed amount of EF class traffic is transmitted in the EF sub-cycle, and AF and BE class traffic are transmitted in the AF sub-cycle. The bandwidth assignment with the two cycles reduces the EF class delay and delay variation, compared to bandwidth assignment with one cycle. It is noted that queue information for the EF class is not reported to the OLT. This is because the EF class is the highest priority class for the delay-sensitive service, such as the constant bit rate (CBR) voice traffic, and accordingly the EF class uses service level agreement (SLA) or a preset fixed bandwidth. On the other hand, queue information for the AF and BE classes of the ONU is delivered to the OLT through a REPORT message in the AF sub-cycle. In response to receiving the queue information, the OLT performs dynamic band assignment in which a minimum bandwidth for each ONU, and thus fairness between ONUs, are guaranteed.

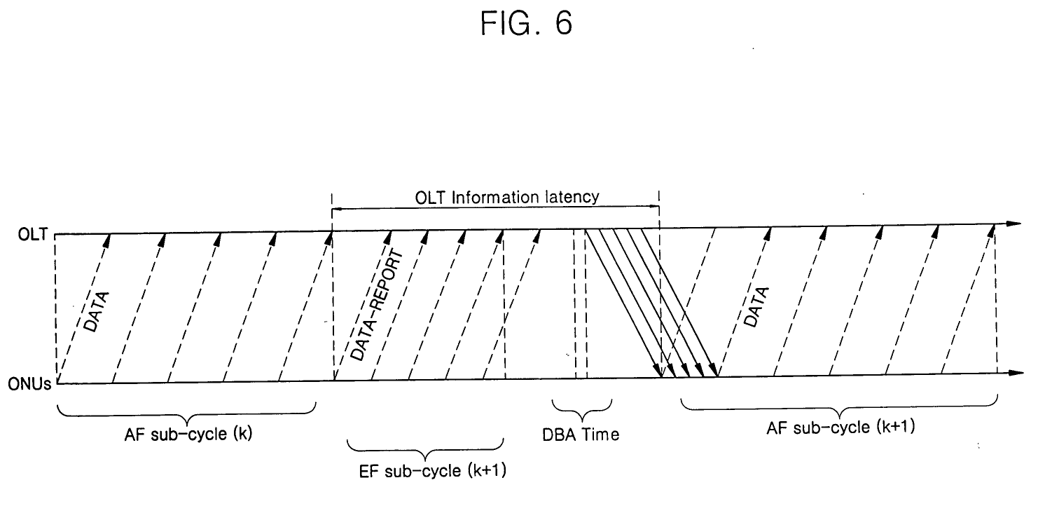

FIG. 6 is a diagram illustrating another HG algorithm according to an exemplary embodiment of the present invention.

The algorithm shown in FIG. 6 is an enhanced version of the HG algorithm shown in FIG. 5. It can be seen that a REPORT message is not transmitted to the OLT in the AF sub-cycle, but it is transmitted to the OLT in the EF sub-cycle in order to reduce OLT information latency of the existing HG algorithm. The algorithm shown in FIG. 6 allows the OLT to obtain more recent ONU queue state information, compared to the existing algorithm.

However, it can be seen that idle time is generated, even in the enhanced HG method shown in FIG. 6. That is, since the ONU queue state is reported to the OLT in the EF sub-cycle, idle time is generated between the EF sub-cycle and the AF sub-cycle.

As a result, because the HG algorithm uses two bandwidth assignment periods as in an existing algorithm, the HG algorithm requires twice the guard time between ONUs of the existing cyclic polling algorithm. In addition, idle time is still present, which is a problem associated with the cyclic polling system.

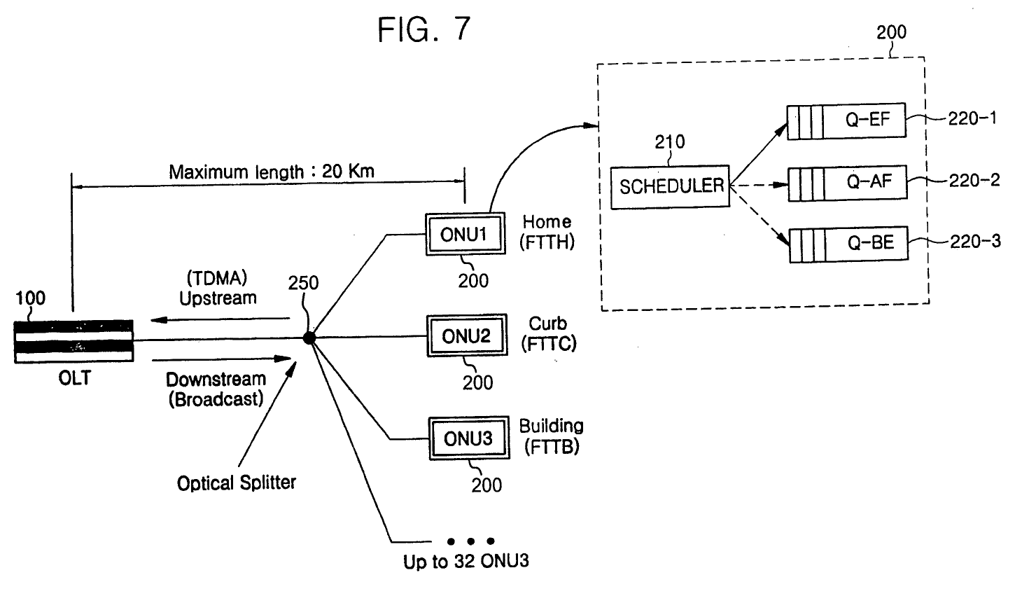

FIG. 7 is a diagram illustrating the configuration of an EPON system according to an exemplary embodiment of the present invention.

Referring to FIG. 7, the EPON system includes an OLT 100, ONUs 200, and an optical splitter 250. As previously described, downstream traffic from the OLT 100 to an ONU 200 is transmitted using a broadcast system, and upstream traffic from an ONU 200 to the OLT 100 is transmitted using a TDMA system.

According to the present invention, the ONU 200 classifies the upstream traffic according to EF, AF and BE classes, manages the classes using Q_EF 220-1, Q_AF 220-2 and Q_BE 220-3, which are queues for respective classes, and monitors AF and BE queue states so as to transmit the queue states to the OLT 100 through a REPORT message. Furthermore, the bandwidth for transmission granted by the OLT 100 is assigned to each class by a scheduler 210 according to the priorities of the AF and BE classes.

Meanwhile, the OLT 100 divides a bandwidth assignment period into an EF sub-cycle 8 and an AF sub-cycle, and performs dynamic band assignment using the reported AF/BE class queue information and fixed EF class information. In this case, a minimum bandwidth for each ONU 200 is set and guaranteed according to a service level agreement (SLA).

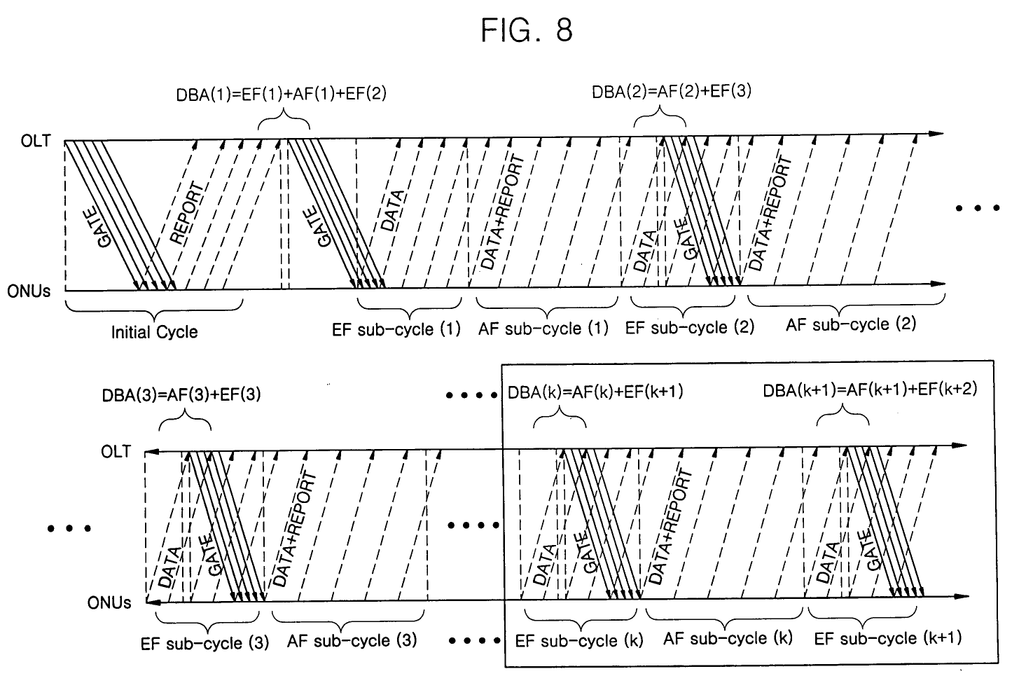

FIG. 8 is a diagram illustrating a method for traffic scheduling in an EPON system according to an exemplary embodiment of the present invention.

In the present invention, a two-cycle assignment method is used to classify traffic according to three classes, such as expedite forwarding (EF), assured forwarding (AF), and best effort (BE) classes, and to support the EF, AF and BE classes. An EF sub-cycle is a cycle for the EF class, and an AF sub-cycle is a cycle for the AF and BE classes. This division into two sub-cycles is due to the fact that it can prevent EF class delay and delay variation, even though it increases the guard time by a factor of two.

EF class traffic can be gated for the EF sub-cycle because of its deterministic characteristic, even when the ONU 200 separately reports to the OLT 100. Such a characteristic allows the use of Transmission Container Type I (T-CONT1) corresponding to the EF class in a fixed manner, instead of a dynamic method to be applied to a Broadband PON (B-PON) or a Gigabit-capable PON (G-PON).

Thus, in the traffic scheduling method according to an exemplary embodiment of the present invention, information about a sum of AF and BE class queue lengths is transmitted, excluding queue length information for the EF class, when the ONU 200 reports to the OLT 100. The OLT 100 performs dynamic band assignment using EF class band information set upon service level agreement (SLA) or by provision, and using the reported AF/BE class queue length information. Furthermore, as shown in FIG. 8, the next EF sub-cycle is assigned in advance, using a characteristic of a fixed EF sub-cycle in order to reduce the idle time.

In an initial cycle of FIG. 8, the OLT performs band assignment on not only EF#1 and AF#1, but also on EF#2. The assigned band is transmitted to each ONU via a GATE, and the ONU transmits data and REPORT to the OLT using the band assigned by the OLT. At this point, each ONU continuously transmits EF#1 and AF#1 traffic, and the EF#2 traffic, to the OLT. It is to be noted that the dynamic band assignment at the OLT is performed after receiving the REPORT transmitted with the AF#1 traffic by the ONU. That is, the OLT performs the dynamic band assignment for the next cycle as soon as it receives the EF#2 traffic from the ONU. It can be seen from FIG. 8 that this procedure is repeated every cycle.

In this manner, idle time is completely eliminated or significantly reduced by performing dynamic band assignment for the next cycle while receiving EF traffic corresponding to the next cycle. When the size of the pre-assigned EF sub-cycle is greater than the idle time, the idle time is completely eliminated. When the size of the EF sub-cycle is smaller than the idle time, the idle time is reduced by the EF sub-cycle.

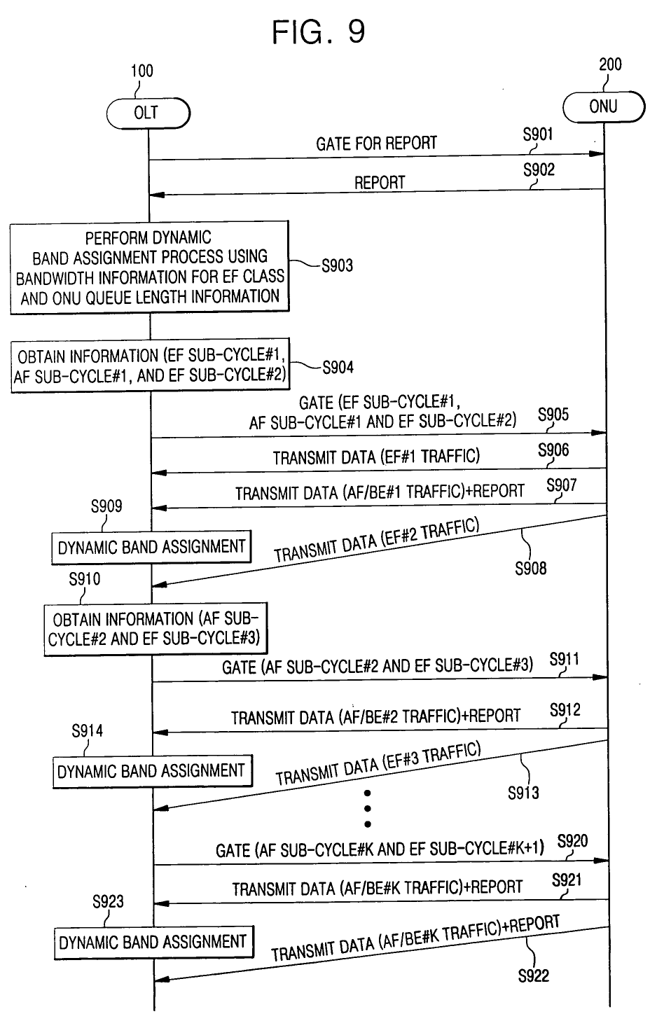

FIG. 9 is a diagram of an operational procedure between the OLT and the ONU according to traffic scheduling of the present invention.

Referring to FIG. 9, in an initial cycle, the OLT 100 transmits GATE for REPORT to the ONU 200 after an auto discovery process is completed (S901). ONU 200 transmits queue length information for the AF and BE classes to the OLT 100 through the REPORT (S902).

In response to receiving the REPORT, the OLT 100 performs a first dynamic band assignment process using preset bandwidth information for the EF class and the queue length information reported by the ONU 200 (S903). When the first dynamic band assignment is completed, a bandwidth assignment amount for EF sub-cycle#1 and AF sub-cycle#1 is obtained (S904). According to the present invention, since the EF sub-cycle is fixed, a value for the EF sub-cycle#2 may be permitted. After performing the first dynamic band assignment process, OLT 100 transmits EF sub-cycle#1, AF sub-cycle#1 and EF sub-cycle#2 information by means of the GATE (S905). The idle time can be reduced by assigning the EF sub-cycle#2 in advance.

In response to receiving the GATE from the OLT 100, the ONU 200 transmits EF traffic by assigned time slot in EF sub-cycle#1 (S906). In FIG. 9, EF#1 indicates the first EF traffic transmitted by the ONU 200 to the OLT 100. Furthermore, the ONU 200 transmits an AF/BE traffic by means of AF sub-cycle#1 contained in the received GATE (S907). At this point, REPORT containing queue length information of the ONU 100 is also transmitted with the AF/BE traffic, i.e., data (S907). The ratio between the AF traffic and the BE traffic is controlled by the ONU 200, as in a typical HG method. Since EF sub-cycle#2 information is contained in the GATE which the ONU 200 receives from the OLT 100, each ONU 200 transmits EF#2 traffic by means of the assigned time slot using the EF sub-cycle#2 information (S908). In this case, the OLT 100 performs dynamic band assignment using the REPORT information received through AF sub-cycle#1 and the fixed EF class bandwidth information (S909). By means of the dynamic band assignment, the OLT 100 can obtain assignment information for AF sub-cycle#2 and EF sub-cycle#3 (S910). The OLT 100 delivers this information to the ONU 200 by means of the GATE message (S911).

It is to be noted that steps S908 and S909, i.e., EF #2 traffic transmission at the ONU 200 and dynamic band assignment at the OLT 100, are not performed sequentially. That is, since step S908 is initiated at a time when all data and REPORT are forwarded by the ONU 200 in S907, and S909 is initiated at a time when the OLT 100 receives the data and the REPORT forwarded by the ONU 200, steps S907 and S908 can be simultaneously performed at different initiation points.

In response to receiving the GATE, the ONU 200 transmits AF/BE#2 traffic by means of the assigned time slot, and reports current queue length information (S912). The ONU 200 also transmits EF#3 traffic during the next EF sub-cycle (S913). In response to receiving the REPORT including the queue length information at S912, the OLT 100 performs dynamic band assignment for the next cycle (S914).

The series of procedures are repeated every cycle. The procedures, when applied to a typical k-th cycle, will be described.

The OLT 100 transmits GATE, including AF sub-cycle#k and EF sub-cycle#k+1, to the ONU 200 (S920). In response to receiving the GATE, the ONU 200 transmits AF/EF#k traffic by means of the assigned time slot using AF sub-cycle#k information (S921). At this point, the OLT 100 performs dynamic band assignment using REPORT received from ONUs 200 (S923). Meanwhile, the ONU 200 transmits the EF traffic by means of the corresponding time slot using EF sub-cycle#k+1 information included in the GATE when AF sub-cycle#k is terminated, and AF/BE traffic forwarding is completed (S922). As described above, the order of steps S922 and S923 is not defined, and the two steps are simultaneously performed.

As described above, according to the traffic scheduling method of the present invention, if the size of the fixed EF sub-cycle is greater than the idle time, the idle time is not generated at all. For example, when the distance between the OLT 100 and the ONU 200 is 20 km, the number of ONUs 200 is 16, a DBA period is 2 ms, DBA_TIME is ignored, and only RTT is considered, the idle time can be completely eliminated when the EF class traffic load for all of the ONUs 200 is more than about 10.2%.

With the traffic scheduling method according to an exemplary embodiment of the present invention, it is possible to improve bandwidth use efficiency by eliminating or reducing idle time. Theoretical maximum processing efficiency (throughput) for the upstream of an algorithm using periodic polling in EPON can be represented by Equation 1:

$${Φ}_{max} = \frac{{BW}_{C} - {BW}_{OH}}{{T}_{C}} \qquad Equation 1$$

where BW_{C} is a bandwidth that can be transmitted in one period, BW_{OH} is a bandwidth of overhead generated in one period, T_{C} is a cycle time, and Φₘₐₓ is theoretical maximum processing efficiency of the upstream. BW_{OH} includes guard time between ONUs, a REPORT message, and an idle time. In Equation 1, BW_{C} and T_{C} have fixed values. Accordingly, it can be seen that the overhead bandwidth BW_{OH} should be reduced to improve the overall processing efficiency.

With the traffic scheduling method according to an exemplary embodiment of the present invention, the overhead bandwidth per one period, BW_{OH}, can be represented by Equation 2:
BW_{OH}=(2×BW_{G}+BW_{R})×N+BW₁ Equation 2
where BW_{G} is a bandwidth for the guard time, BW_{R} is a bandwidth for the REPORT message, and BW₁ is a bandwidth for the idle time.

The overhead bandwidths, according to the traffic scheduling method of an exemplary embodiment of the present invention, and according to the existing typical cyclic polling method and the HG algorithm, will be discussed by means of a comparison. For convenience of illustration, it is assumed that a typical cyclic polling method is a regular one, the method having the sub-cycle division characteristic as illustrated in FIG. 5 is HG, and the traffic scheduling method according to an exemplary embodiment of the present invention is High Utilization Hybrid Granting (HUHG).

The overhead bandwidth according to the typical cyclic polling method can be represented by Equation 3:
BW_{OH-Re gular}=(BW_{G}+BW_{R})×N+BW₁ Equation 3

Furthermore, the overhead bandwidth according to the HG method can be represented by Equation 4:
BW_{OH-HG}=(2×BW_{G}+BW_{R})×N+BW₁ Equation 4

By comparing Equations 3 and 4, it can be seen that the HG method needs twice the guard time of the regular algorithm because it has two bandwidth assignment periods. The idle time on which the bandwidth use efficiency depends is always generated in both the regular method and the HG method. However, in the case of the HUHG method, the idle time is not generated at all when the EF sub-cycle is equal to or greater than the idle time bandwidth. Accordingly, from Equation 2, the following Equation 5 is obtained:
BW_{OH-HUNG}=(2×BW_{G}+BW_{R})×N Equation 5

Equation 5 is satisfied only when “EF sub-cycle≧BW₁.” However, in typical traffic in which the EF traffic is generated, the EF sub-cycle is usually much greater than the idle time bandwidth. Thus, Equation 5 may be satisfied in most cases.

Meanwhile, in order to implement the scheduling method in which the bandwidth assignment for the EF and AF/BE classes is divided into two, and an EF sub-cycle in the next period is assigned in advance as described above, the dynamic band assignment method needs to be different from the existing method. The dynamic band assignment method according to an exemplary embodiment of the present invention will be described.

First, a bandwidth BW^{Avail} which is available per one period for the upstream can be represented by Equation 6:
BW^{AVAIL}−BW^{C}−BW^{OH} Equation 6
where BW^{C} denotes a bandwidth corresponding to one period, and BW^{OH} denotes the overhead bandwidth. As described above, the overhead bandwidth BW^{OH} can be represented by Equation 5 when the EF class bandwidth is greater than the idle time bandwidth according to an exemplary embodiment of the present invention. If the EF class bandwidth is smaller than the idle time bandwidth, the overhead bandwidth BWOH can be represented by the following Equation 7:

$${BW}_{OH} = ( 2 \times {BW}_{G} + {BW}_{R} ) \times N + ( {BW}^{1} - {\sum }_{i = 1}^{N} {BW}_{i}^{EF} ) \qquad Equation 7$$

where BW¹ denotes a bandwidth for the idle time, and BWᵢ^{EF} denotes an EF class bandwidth for the i-th ONU. A minimum assured bandwidth should be assigned to each ONU in order to provide fairness among the ONUs. BW^{Avail} is divided and assigned according to weights among ONUs. The minimum assured band BWᵢ^{Min} for the i-th ONU is represented by Equation 8:

$${BW}_{i}^{Min} = {ω}_{i} \times {BW}^{Avail} ( {\sum }_{i = 1}^{N} {ω}_{i} = 1 ) \qquad Equation 8$$

The assignment of the bandwidth for the EF and AF/BE classes using the above-described equations will be described. First, since the EF class uses a fixed bandwidth, G_{i,k}^{EF} and G_{i,k+}1^{EF} indicating bandwidth approval for k-th and k+1-th cycles in the i-th ONU for the EF class, can be represented by Equation 9:
G_{i,k}^{EF}=BWᵢ^{EF},G_{i,k+}1^{EF}=BWᵢ^{EF} Equation 9

It can be seen from Equation 9 that, in the i-th ONU, the band assigned to the EF class is constant irrespective of cycle.

For the AF/BE class, the bandwidth of the upstream should be maximally used with REPORT R_{i,k} information of the ONU for the k-th cycle in the i-th ONU. For this, it is necessary to obtain an excessive amount Vₖ^{Dem} determined by ONUs requiring an amount exceeding BWᵢ^{Min}, and an amount Vₖ^{Ex} remaining by ONUs requiring an amount less than BWᵢ^{Min} in the k-th cycle. Vₖ^{Dem} and Vₖ^{Ex} can be calculated by Equations 10 and 11:

$$\begin{matrix}{V}_{k}^{Dem} = {\sum }_{i ∈ L} ( {G}_{l , k}^{EF} + {R}_{l , k} ) - {BW}_{l}^{Min} ( L \text{:} {G}_{l , k}^{EF} + {R}_{l , k} > {BW}_{l}^{Min} ) , and & Equation 10 \\ {V}_{k}^{Ek} = {\sum }_{j ∈ J} ( {BW}_{j}^{Min} - {G}_{j , k}^{EF} - {R}_{j , k} ) ( J \text{:} {G}_{j , k}^{EF} + {R}_{j , k} < {BW}_{j}^{Min} ) & Equation 11\end{matrix}$$

Meanwhile, when Vₖ^{Ex} is greater than Vₖ^{Dem} or when R_{i,k} is smaller than a value obtained by subtracting G_{i,k}^{EF} from BWᵢ^{Min}, R_{i,k} is assigned and approved as is. Otherwise, the Vₖ^{Ex} band is additionally approved in proportion to the requested amount, and is assigned to the ONUs belonging to an L group, as in Equation 12:

$${G}_{l , k}^{Add} = {V}_{k}^{Ex} \times \frac{{V}_{l , k}^{Dem}}{{V}_{k}^{Dem}} \qquad Equation 12$$

where G_{1,k}^{Add} denotes a bandwidth that is additionally assigned and approved to ONUs belonging to the L group in the k-th cycle. Furthermore, Vₖ^{Ex} denotes a surplus over the amount needed by ONUs requiring a bandwidth smaller than BWᵢ^{Min}, Vₖ^{Dem} denotes an excessive amount needed by ONUs requiring a bandwidth exceeding BWᵢ^{Min} in the k-th cycle, and V_{1,k}^{Dem} denotes an excessive amount needed by the 1-th ONU exceeding BWᵢ^{Min} in the k-th cycle.

From Equations 6 to 12, Equations 13 and 14 are obtained:

$$\begin{matrix}∴ {G}_{i , k}^{AF} = \{ \begin{matrix}{R}_{i , k} , {V}_{k}^{Dem} \leq {V}_{k}^{Ex} or {R}_{i , k} + {G}_{i , k}^{EF} \leq {BW}_{i}^{Min} \\ {BW}_{i}^{Min} - {G}_{i , k}^{EF} + {G}_{i , k}^{Add} , Otherwise\end{matrix} , and & Equation 13 \\ {G}_{i , k}^{EF} = {BW}_{i}^{EF} , {G}_{i , k + 1}^{EF} = {BW}_{i}^{EF} & Equation 14\end{matrix}$$

where G_{i,k}^{AF} indicates bandwidth approval for the k-th cycle in the i-th ONU for the AF class, R_{i,k} indicates REPORT information in the ONU for the k-th cycle of the i-th ONU, BWᵢ^{Min} indicates a minimum assured band of the i-th ONU, G_{i,k}^{EF} indicates bandwidth approval for the k-th cycle of the i-th ONU for the EF class, and G,_{i,k}^{Add} denotes a bandwidth that is additionally approved and assigned to an ONU belonging to an i group in the k-th cycle. Furthermore, G_{i,k}^{EF} and G_{i,k+1}^{EF} denote bandwidth approval for k and k+1 cycles, respectively, in the i-th ONU for the EF class.

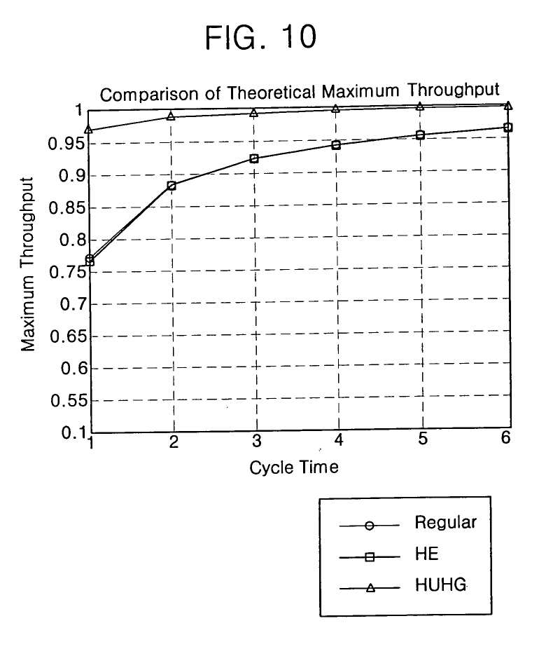

FIG. 10 is a graph illustrating an expected theoretical value of the maximum use efficiency when traffic scheduling is performed according to an exemplary embodiment of the present invention, as compared to that of another existing method.

FIG. 10 shows the result obtained by applying values to Equations 3, 4 and 5 while changing a period when a distance between the ONU 200 and the OLT 100 is 20 km, i.e., round trip time (RTT) is 200 μs. The difference in bandwidth use efficiency between the regular method and the HG method is significantly small, as shown in FIG. 10. However, it can be seen that there is a great difference in bandwidth use efficiency between the HUHG method and the regular or HG method. That is, it can be seen that a 1 ms period improves the bandwidth use efficiency by about 15%, and a 2 ms period improves it by about 10%.

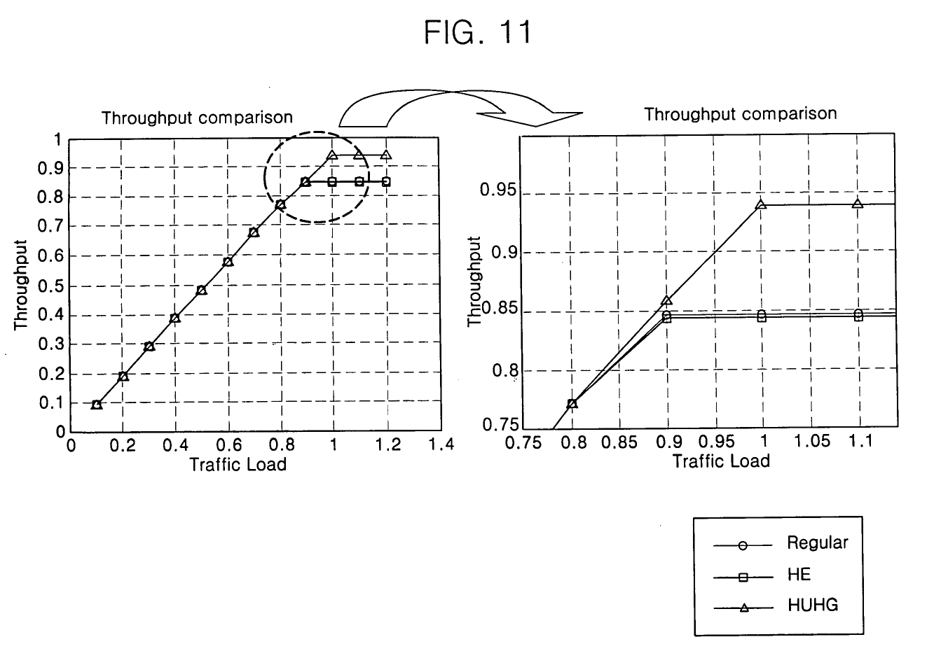

FIG. 11 is a graph illustrating an experimental value of use efficiency with respect to a traffic load when traffic scheduling is performed according to an exemplary embodiment of the present invention, as compared to that of another existing method.

A simulated network environment used in the simulation includes the OLT 100 and twenty ONUs 200, in which the upstream/downstream transmission rate between the OLT 100 and the ONU 200 is 1 Gbps, the distance between the OLT 100 and the ONU 200 is 20 km, and RTT is 200 μs. Furthermore, the guard time is set as 1 μs, the period is set as 2 ms, and the REPORT size is set as 64 bytes for experiment.

To more substantially simulate the traffic environment in a WAN, the packet size distribution for AF and BE class traffic has probabilities of 60%, 25% and 15% for 64, 570 and 1518 bytes, respectively. Exponential distribution is used as the traffic distribution, and CBR traffic of a fixed 64 bytes is used for the EF class.

Since the EF class is a narrow band, 20% of the overall traffic load is assigned for EF class service, and the remaining 80% is assigned for the AF and BE class services, i.e., 40% for AF and 40% for BE. Accordingly, idle time is not generated because, in this state, the EF sub-cycle is greater than the idle time.

In order to simplify the simulation, it is assumed that priorities among ONUs are all the same, and all of the ONUs cause the same traffic load. In an ONU, a scheduler is first adapted to schedule the AF and BE traffic at a ratio of 6:4. The network use efficiency, the queuing latency of each class, and the delay variation of the EF class were measured while changing the overall traffic load. The measurement results show that the queuing latency of each class and the delay variation are improved by the HUHG method according to an exemplary embodiment of the present invention, and they are especially significantly improved in terms of network use efficiency.

Thus, FIG. 11 is a graph of use efficiency results. It can be seen that the use efficiencies of the existing algorithm and HUHG algorithm are the same for a traffic load of 0 to 0.8, while the HUHG algorithm provides higher use efficiency for a traffic load of 0.9 or greater. To observe the use efficiency for a traffic load of 0.8 or greater, a portion of the graph of FIG. 11 is magnified. While the maximum use efficiency of the HG method is 0.843 and the maximum use efficiency of the regular method is about 0.846, the maximum use efficiency of the HUHG method having no idle time is up to 0.937. Thus, it can be seen that the HUHG method provides use efficiency improvement of about 10%, compared to the existing method.

The present invention provides the next EF cycle information in an initial cycle using the modified dynamic bandwidth assignment in the EPON system in advance, thereby eliminating or reducing idle time and providing higher bandwidth use efficiency.

While the present invention has been described with reference to exemplary embodiments thereof, it will be understood by those skilled in the art that various changes in form and detail may be made therein without departing from the scope of the present invention as defined by the following claims.

What is claimed is:

1. A method for traffic scheduling in an Ethernet passive optical network (EPON) system, the method comprising the steps of:
dividing a periodic transmission cycle between an optical line termination (OLT) and an optical network unit (ONU) for upstream traffic time band assignment into an Expedited Forwarding (EF) sub-cycle preset for EF traffic and an Assured Forwarding (AF) sub-cycle dynamically set for AF and BE traffic;
dynamically assigning, by means of the OLT receiving ONU queue length information from the ONU, a first AF sub-cycle band using the ONU queue length information and the preset EF sub-cycle band; and
granting to the ONU, by means of the OLT, a first preset EF sub-cycle, the dynamically assigned first AF sub-cycle band, and a second preset EF sub-cycle band.

2. The method according to claim 1, further comprising the steps of:
transmitting, by means of the ONU, DATA including the AF and BE traffic, and REPORT including the queue length information for each traffic, to the OLT using the dynamically assigned first AF sub-cycle band granted by means of the OLT; and
transmitting, by means of the ONU, the EF traffic to the OLT using the second EF sub-cycle band granted by means of the OLT.

3. The method according to claim 2, further comprising the steps of:
receiving, at the OLT, the EF traffic from the ONU, dynamically assigning a second AF sub-cycle band using the ONU queue length information and a third preset EF sub-cycle band; and
granting to the ONU, by means of the OLT, the dynamically assigned second AF sub-cycle band and the third EF sub-cycle band.

4. The method according to claim 3, further comprising the steps of:
transmitting, by means of the ONU, DATA including the AF and BE traffic, and REPORT including queue length information for each traffic, to the OLT using an n-th AF sub-cycle band granted by the OLT; and
transmitting, by means of the ONU, the EF traffic to the OLT using an n+1-th EF sub-cycle band granted by the OLT.

5. The method according to claim 4, further comprising the steps of:
receiving, at the OLT, the EF traffic from the ONU, and dynamically assigning an n+1-th AF sub-cycle band using the received ONU queue length information and a preset n+2-th EF sub-cycle band; and
granting the dynamically assigned n+1-th AF sub-cycle band and the preset n+2-th EF sub-cycle band to the ONU, where n is a natural number not less than 2.

6. The method according to claim 1, wherein a band assigned to the EF sub-cycle is the same during every cycle for a same ONU.

7. A method for traffic scheduling in an Ethernet passive optical network (EPON) system, the method comprising the steps of:
dividing a periodic transmission cycle between an optical line termination (OLT) and an optical network unit (ONU) for upstream traffic time band assignment into an Expedited Forwarding (EF) sub-cycle preset for EF traffic and an Assured Forwarding (AF) sub-cycle dynamically set for AF and BE traffic;
performing a first cycle step, at the OLT, of dynamically assigning, by means of the OLT receiving ONU queue length information from the ONU, a first AF sub-cycle band using the ONU queue length information and the preset EF sub-cycle band, and granting to the ONU a first preset EF sub-cycle, the dynamically assigned first AF sub-cycle band, and a second preset EF sub-cycle band; and
performing a first cycle step, at the ONU, of transmitting, by means of the ONU, DATA including the AF and BE traffic, and REPORT including the queue length information for each traffic, to the OLT using the dynamically assigned first AF sub-cycle band granted by the OLT, and transmitting the EF traffic to the OLT using the second preset EF sub-cycle band granted by the OLT.

8. The method according to claim 7, further comprising:
performing a second cycle step, at the OLT, of receiving, by means of the OLT, second EF traffic from the ONU, dynamically assigning a second AF sub-cycle band using the ONU queue length information and a third preset EF sub-cycle band, and granting the dynamically assigned second AF sub-cycle band and a third EF sub-cycle band to the ONU; and
performing a second cycle step, at the ONU, of transmitting, by means of the ONU, DATA including the AF and BE traffic, and REPORT including queue length information for each traffic, to the OLT using the dynamically assigned second AF sub-cycle band granted by the OLT, and transmitting the EF traffic to the OLT using the third EF sub-cycle band granted by the OLT.

9. The method according to claim 8, further comprising:
performing an n-th cycle step, at the OLT, of receiving, by means of the OLT, the EF traffic from the ONU, dynamically assigning an n-th AF sub-cycle band using the received ONU queue length information and an n-th preset EF sub-cycle, and granting the dynamically assigned n-th AF sub-cycle band and an n+1-th EF sub-cycle band to the ONU; and
performing an n-th cycle step, at the ONU, of transmitting, by means of the ONU, DATA including the AF and BE traffic, and REPORT including queue length information for each traffic, to the OLT using the dynamically assigned n-th AF sub-cycle band granted by the OLT, and transmitting the EF traffic to the OLT using the n+1-th EF sub-cycle band granted by the OLT, wherein n is a natural number not less than 3.

10. An optical line termination (OLT) in an Ethernet passive optical network (EPON) system in which a periodic transmission cycle for upstream traffic time band assignment is divided and used for different types of traffic, wherein the OLT receives optical network unit (ONU) queue length information from an ONU, dynamically assigns a first Assured Forwarding (AF) sub-cycle band using the queue length information and a preset Expedited Forwarding (EF) sub-cycle band, and grants to the ONU a first preset EF sub-cycle band, the dynamically assigned first AF sub-cycle band, and a second preset EF sub-cycle band.

11. The optical line termination according to claim 10, wherein the OLT performs an n-th cycle in which the OLT receives EF traffic from the ONU, dynamically assigns an n-th AF sub-cycle band using the received ONU queue length information and an n+1-th preset EF sub-cycle band, and grants to the ONU the dynamically assigned n-th AF sub-cycle band and the preset n+1-th EF sub-cycle band, wherein n is a natural number not less than 2.

12. The optical line termination according to claim 10, wherein a band assigned to an EF sub-cycle is the same during every cycle for a same ONU.

13. An Ethernet passive optical network (EPON) system in which a periodic transmission cycle for upstream traffic time band assignment is divided and used for different types of traffic, the system comprising:
an optical line termination (OLT) for receiving optical network unit (ONU) queue length information from an ONU, for dynamically assigning a first Assured Forwarding (AF) sub-cycle band using the received ONU queue length information and a first preset Expedited Forwarding (EF) sub-cycle band, and for granting to the ONU the first preset EF sub-cycle band, the dynamically assigned first AF sub-cycle band, and a second preset EF sub-cycle band; and
at least one ONU for transmitting DATA including AF traffic and BE traffic, and REPORT including queue length information for each traffic, to the OLT using the dynamically assigned first AF sub-cycle band granted by the OLT, and for transmitting EF traffic to the OLT using the second preset EF sub-cycle band granted by the OLT.

14. The EPON system according to claim 13, wherein the OLT receives the EF traffic from the ONU, dynamically assigns an n-th AF sub-cycle band using the received ONU queue length information and an n+1-th preset EF sub-cycle band, and grants the dynamically assigned n-th AF sub-cycle band and the n+1-th preset EF sub-cycle band to the ONU, wherein n is a natural number not less than 2.

15. The EPON system according to claim 14, wherein the ONU transmits DATA including the AF traffic and the BE traffic, and REPORT including queue length information for each traffic, to the OLT using the dynamically assigned n-th AF sub-cycle band granted by the OLT, and transmits the EF traffic to the OLT using the n+1-th preset EF sub-cycle band granted by the OLT, wherein n is a natural number not less than 2.
